(19) United States
(12) Patent Application Publication
(10) Pub. No.: US 2008/0126747 A1
(43) Pub. Date: May 29, 2008

(54) METHODS AND APPARATUS TO IMPLEMENT HIGH-PERFORMANCE COMPUTING

(76) Inventors: Jeffrey L. Griffen, North Plains, OR (US); Mark S. Doran, Olympia, WA (US); Vincent J. Zimmer, Federal Way, WA (US); Michael A. Rothman, Puyallup, WA (US)

Correspondence Address: Hanely Flight & Zimmerman, LLC, 150 S. Wacker Drive, Suite 2100, Chicago, IL, 60606, US

(21) Appl. No.: 11/564,086

(22) Filed: Nov. 28, 2006

(51) Int. Cl. G06F 7/483; G06F 7/38

(52) U.S. Cl. 712/25; 708/490; 712/E09.017

(57) ABSTRACT

Apparatus and methods to implement high-performance computing are disclosed. An example method comprises executing a first operating system in a first partition to detect an arithmetic instruction, using an inter-partition bridge to notify a second partition of the arithmetic instruction, and processing the arithmetic instruction in the second partition with a second operating system.

### FIELD OF THE DISCLOSURE

This disclosure relates generally high-performance computing and, more particularly, to methods and apparatus to implement high-performance computing.

### BACKGROUND

High-performance computing may be implemented using specialized co-processors that are coupled to, for example, a general-purpose processor executing a general execution environment (e.g., a general-purpose operation system (OS) such as Microsoft® Windows® XP). Such customized co-processors may be coupled to the general-purpose processor via any variety of general, customized and/or proprietary computer bus(es) and/or protocols. To utilize such a co-processor, the general-purpose OS needs to implement and/or provide an interface to the co-processor. Moreover, a system that does not implement and/or contain such a specialized co-processor may be incapable of supporting an OS that implements such interfaces. Further still, the general execution environment cannot exploit, for example, non-standard instruction set architecture (ISA) extensions that may be most efficiently executed on specially designed hardware cores.

### BRIEF DESCRIPTION OF THE DRAWINGS

FIG. 1 is a schematic illustration of an example high-performance computing system constructed in accordance with the teachings of the invention.

FIG. 2 illustrates an example manner of implementing an example arithmetic optimizer for the example high-performance computing system of FIG. 1.

FIG. 3 illustrates example source code that may be executed to implement the example library of FIG. 2.

FIG. 4 is a flowchart representative of example machine readable instructions which may be executed to implement the example arithmetic offloader of FIG. 2 and/or, more generally, the example high-performance computing system of FIG. 1.

FIG. 5 illustrates an example implementation of vector arithmetic on the example computing system of FIG. 1.

### DETAILED DESCRIPTION

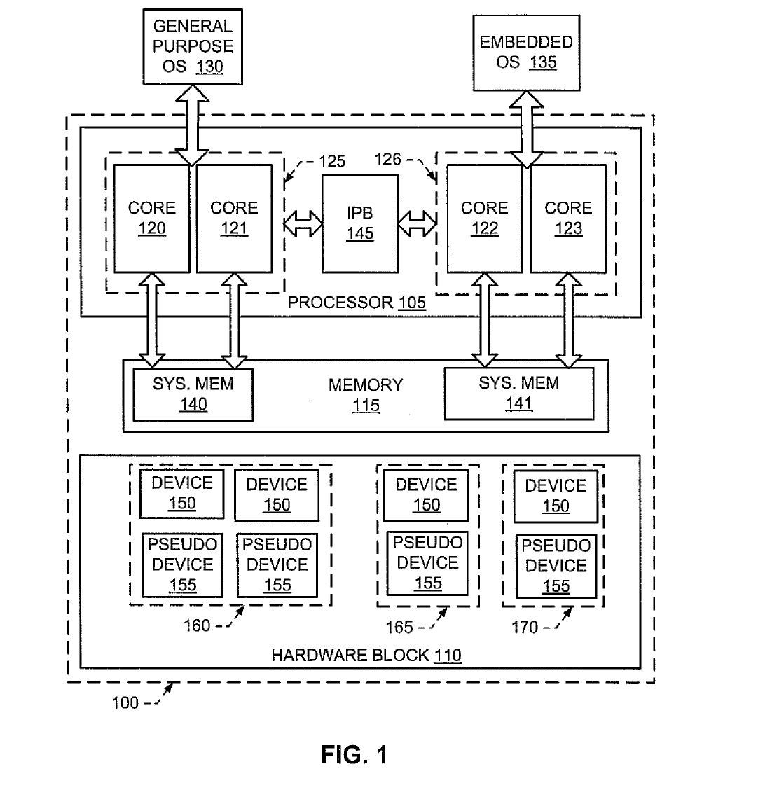

FIG. 1 is a schematic illustration of an example high-performance computing system 100 constructed in accordance with the teachings of the invention. In the interest of brevity and clarity, throughout the following disclosure references will be made to the example processor system 100 of FIG. 1. However, persons of ordinary skill in the art will readily appreciate that the methods and apparatus described herein to implement high-performance computing system can be applied to any number and/or type(s) of computing and/or processor systems.

To execute machine accessible instructions, the example system 100 of FIG. 1 includes any number and/or type(s) of processors 105, any number and/or type(s) of hardware blocks 110, and any number and/or type(s) of system memories 115. The example processor 105 of FIG. 1 is a processor that implements any number and/or type(s) of cores, processor cores and/or central processor units (CPUs), four of which are illustrated in FIG. 1 with reference numerals 120, 121, 122 and 123. Of course, alternative, additional and/or fewer cores may be used to implement an example processor 105. The example processor 105 is an integrated circuit (IC), such as a semiconductor IC chip, and is a processor from the Intel® family of processors, such as the Intel® Core® and Intel® Pentium® D processor families, and the example cores 120-123 of FIG. 1 are low power Intel architecture (LPIA) cores.

In the example processor system 100 of FIG. 1, the cores of the multi-core processor 105 may be logically and/or physically divided into any number and/or type(s) of partitions, two of which are illustrated in FIG. 1 with reference numbers 125 and 126. For example, as illustrated in FIG. 1, the multi-core processor 105 may be divided to implement a general partition 125 including the cores 120 and 121, and an embedded or sequestered partition 126 including the cores 122 and 123. Each of the partitions 125 and 126 need not include the same number and/or type(s) of cores 120-123.

In the illustrated example of FIG. 1, the general partition 125 implements a main operating system (OS) 130, which may be, for example, a general-purpose OS such as Microsoft® Windows XP®, Linux, Solaris®, etc. The example embedded partition 126 of FIG. 1 is capable of implementing an embedded OS 135 such as a lightweight array operation system or a sequestered runtime operating system (e.g., ThreadX® or Embedded Linux). A typical embedded OS 135 puts very little software and/or few software layers between functions and/or routines supported by the embedded partition 126 and the cores 122, 123 of the embedded partition 126. The embedded OS 135 may be implemented, customized, tailored and/or optimized for the cores 122 and 123 and/or to accelerate arithmetic operations and/or instructions. For example, the embedded OS 135 may implement, but is not limited to implementing, arithmetic operations from a basic linear algebra subprograms (BLAS) library, vector instructions, array instructions, matrix math extension (MMX) instructions, streaming singled instruction multiple data (SSE) instructions, and/or vector SSE (VSSE) instructions. The example embedded OS 135 and the example embedded partition 126 of FIG. 1 may also be used to accelerate the execution of arithmetic instructions and/or operations. The embedded OS 135 and the embedded partition 126 may be used to implement instructions not directly supported by any or all of the example cores 120, 121 of the main partition 125. For example, if none of the cores 120, 121 of the main partition supports SSE or VSSE instructions, a software agent executed by and/or on the example main OS 130 can trap an undefined exception fault and then re-direct the call to the embedded partition 126. Alternatively or additionally, the software agent could trap supported and/or unsupported instructions that may be more efficiently executed on the embedded partition 126.

In the example processor system of FIG. 1, the system memory 115 may include, for example, one or more of the following types of memories: semiconductor firmware memory, programmable memory, non-volatile memory, read-only memory (ROM), electrically programmable memory, random-access memory (RAM), flash memory (which may include, for example, NAND or NOR type memory structures), magnetic disk memory, and/or optical disk memory. Additionally or alternatively, the system memory 115 may be other and/or later-developed types of computer-readable memory. The example system memory 115 may be used to store machine-accessible instructions, such as the example machine accessible instructions of FIGS. 3 and/or 4. As described below, these instructions may be accessed and/or executed by the example cores 120-123 of the general partition 125 and/or the embedded partition 126 of the multi-core processor 105.

In example system 100 of FIG. 1, the system memory 115 may be logically and/or physically partitioned into a first system memory 140 and a second system memory 141. The example system memory 140 of FIG. 1 may store commands, instructions, and/or data for operation of the general partition 125, such as the main OS 130. Likewise, the example system memory 141 may store commands, instructions, and/or data for execution on the embedded partition 126, such as execution of the embedded OS 135.

In the example processor system of FIG. 1, the hardware block 110 may include any number and/or type(s) of IC chips, such as those selected from IC chipsets (e.g., graphics, memory and/or I/O controller hub chipsets), although other IC chips may also, or alternatively, be used. In some examples, all or any portion of hardware block 110 is implemented and/or managed as a platform resource layer (PRL) that presents the hardware resource(s) of the PRL with a known and/or containerized interface. Such PRLs abstract hardware resources for the general partition 125 and/or the embedded partition 126. When PRLs are implemented, the partitions 125, 126 include PRL runtime routines that allow software executing within the partitions 125, 126 to access the hardware resource(s) of the PRLs.

The example hardware block 110 of FIG. 1 includes devices 150 and pseudo-devices 155 that may be, for example, controllers, storage devices, media cards (video, sound, etc.) and/or network cards. The example pseudo-devices 155 of FIG. 1 are emulated devices. In the illustrated example, certain devices 150 and pseudo devices 155 are designated as and/or assigned to a general hardware block 160 that is controllable only by the cores 120, 121 of the example general partition 125. Likewise, certain devices 150 and pseudo-devices 155 are designated as and/or assigned to an embedded hardware block 165 that is controllable only by the cores 122, 123 of the example embedded partition 126. Further still, certain devices 150 and pseudo-devices 155 are designated as and/or assigned to a shared hardware block 170 that is controllable by the cores 120-123 of the general partition 125 and/or the embedded partition 126. The example shared hardware block 170 may implement, for example, an inter-partition bridge (IPB) circuit if any or all of an IPB 145 of FIG. 1 that is implemented in hardware in the form of an I/O controller, for example.

The example main OS 130 of FIG. 1 is capable of generating one or more I/O requests (e.g., read and/or write requests) directed to the example devices 150 and example pseudo-devices 155 in the hardware block 110. To that end, the general partition 125 is capable of communicating with the hardware block 110 using a plurality of communication protocols. For example, the example general partition 125 may be capable of communicating with the devices 150 or pseudo devices 155 using the serial advanced technology attachment (SATA) communications protocol and/or parallel advanced technology attachment (PATA) communications protocol.

To allow the example general partition 125 and example embedded partition 126 to communicate, the example processor system 100 of FIG. 1 includes the example IPB 145. The example IPB 145 of FIG. 1 is implemented as shared memory between the general partition 125 and the embedded partition 126. Additionally or alternatively as described below, the example IPB 145 may be a hardware-oriented interconnect such as any type of input/output controller.

For example, in response to an I/O request generated by the main OS 130, the example general partition 125 of FIG. 1 may be directed to a hardware device 150, 155 in the shared hardware block 170. For example, the IPB 145 may generate an interrupt to the embedded partition 126 that notifies the embedded partition 126 to process the I/O request generated by the main OS 130. In response to the interrupt generated by the IPB 145, the example embedded partition 126 of FIG. 1 may translate the I/O request from a communication protocol implemented by the general partition 125 into a same and/or different communication protocol compatible with the device receiving the I/O request. Once the I/O transaction is complete (or if the I/O transaction fails), the example embedded partition 126 of FIG. 1 reports the status of the I/O transaction to the general partition 125 via the IPB 145. Each of the example cores 122 and 123 implements a respective interface to hardware, such as a peripheral component interconnect (PCI) interface, to implement access to the pseudo devices 155 and/or the real devices 150 of the shared hardware block 170.

While an example processor system 100 has been illustrated in FIG. 1, the devices, cores, processors, memories, blocks and/or partitions illustrated in FIG. 1 may be combined, divided, re-arranged, eliminated and/or implemented in any of a variety of ways. Moreover, a processor system may include and/or implement additional devices, cores, processors, memories, blocks and/or partitions than those illustrated in FIG. 1 and/or may include more than the number of illustrated devices, cores, processors, memories, blocks and/or partitions.

The separation of the embedded partition 126 and the use of the IPB 145 allow use of hidden architectures unknown to the main operating system 130. Use of the embedded partition 126 is opaque to the main operating system 130, thus allowing processor designers of CPUs in the embedded partition 126 to keep hardware details hidden from and/or not needed by the software designers of the main operating system 130. Such hardware designs may be tailored to optimize performance for specific functions such as executing certain computer instructions and/or languages. Those of ordinary skill in the art will appreciate that the processor system is also flexible in that different processors may be used for the embedded partition. The embedded partition may also be updated and use a more advanced processing using non-standard architectures for example or operating systems which have superior processing of a workload than the general partition without having to make modifications to the general operating system on the general partition.

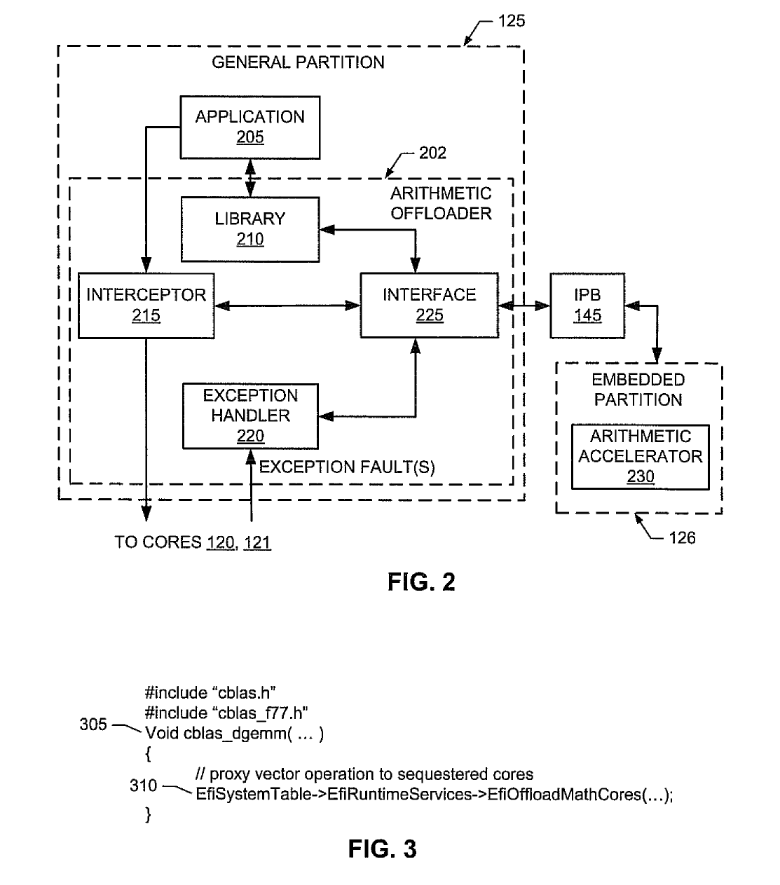

FIG. 2 is a schematic illustration of an example arithmetic offloader 202 that may, for example, be executed by and/or within the general partition 125 and/or, more specifically, may be executed by and/or within the example general-purpose OS 130 of FIG. 1. The example arithmetic offloader 202 of FIG. 2 may be provided and/or implemented separately from the general-purpose OS 130. Thus, the OS 130 does not require built-in and/or integrated support for either the arithmetic offloader 202 and/or for arithmetic operations provided by and/or implemented by the embedded partition 126. However, all or a portion of the arithmetic offloader 202 may be provided and/or implemented as a part of a general-purpose OS 130. In general, the example arithmetic offloader 202 of FIG. 2 facilitates high-performance computing for an example application 205. The example application 205 of FIG. 2 may be any type(s) of application that may be executed on and/or within the general partition 125 and/or, more specifically, within and/or by the general-purpose OS 130. Example applications 205 include any type of user application, a gaming application, a simulator, a video application, etc.

To facilitate high-performance computing, the example arithmetic offloader 202 of FIG. 2 includes one or more of a library 210, an interceptor 215 and an exception handler 215. Which, or all, of the library 210, the interceptor 215 and the exception handler 215 are implemented by a particular arithmetic offloader 202 depends upon the type(s) of arithmetic instructions and/or operations that are accelerated and/or supported by the example arithmetic offloader 202 of FIG. 2. For example, a first arithmetic offloader 202 includes only the exception handler 220 that identifies and directs instructions that are undefined by and/or for the cores 120, 121 to the embedded partition 126 for execution. Another arithmetic offloader 202 includes only the library 210 to accelerate the execution of a set of arithmetic functions and/or routines. Persons of ordinary skill in the art will readily recognize that any other combinations of the library 210, the interceptor 215 and the exception handler 215 may be implemented.

To accelerate the execution of library function calls to, for example, a BLAS library, the example arithmetic offloader 202 of FIG. 2 includes the library 210. The example library 210 of FIG. 2 includes one or more application programming interfaces (e.g., function call interfaces) to, for example, routines and/or functions provided and/or implemented by the library 210. In particular, the example library 210 of FIG. 2 includes a library and/or set of functions and/or routines stored and/or implemented as a library and/or set of machine accessible instructions that may be called by other applications (e.g., the example application 205) executing within the example general partition 125.

An optimized routine of the example library 210 causes execution of a corresponding routine within the embedded partition 126 rather than execution of the routine directly within the general partition 125. In particular, the optimized routine implements, for example, a stub function that causes a corresponding function implemented by and/or within the embedded partition 126 to be executed. In the example processor system 100 of FIG. 1, such functions implemented by and/or on the embedded partition 126 can be accelerated, tailored, customized and/or optimized for execution within the embedded partition 126. An example optimized routine of the library 205 is described below in connection with FIG. 3.

To intercept the execution of arithmetic instruction and/or operations, the example arithmetic offloader 202 of FIG. 2 includes the interceptor 215. Using any number and/or type(s) of method(s), technique(s) and/or logic, the example interceptor 215 of FIG. 2 intercepts an instruction and/or operation, such as SSE or VSSE instructions, before they are executed by a core of the general partition 125 (e.g., one of the cores 120, 121). In particular, by intercepting instructions that are not supported by the cores 120, 121, the example interceptor 215 causes the instruction and/or operation to be implemented and/or carried out by the embedded partition 126. Thus, rather than the cores 120, 121 causing, for example, an undefined exception fault due to an unsupported instruction, the example interceptor 215 can intercept such instructions before the cores 120, 121 attempt to execute them.

To handle undefined exception faults, the example arithmetic offloader 202 includes the exception handler 220. The example exception handler 220 of FIG. 2 processes undefined exception faults to identify instructions that are not supported by the cores 120, 121 of the general partition 125 but are supported by the embedded partition 126. When undefined exception faults caused by such instructions are identified, the exception handler 220 causes the instruction and/or operation to be implemented and/or carried out by the embedded partition 126.

To provide an interface to the embedded partition 126 via the IPB 145 (FIG. 1), the example arithmetic offloader 202 of FIG. 2 includes an interface 225. Based upon a particular type of IPB 145 implemented by a particular processor system (e.g., a shared memory IPB, a input/output controller IPB, etc.), the example interface 225 of FIG. 2 implements logic and/or control that allows any of the library 210, the interceptor 215 and the exception handler 215 to call and/or cause routines, instructions and/or functions provided and/or implemented by the embedded partition 126 to be executed. The example interface 225 also allows any of the library 210, the interceptor 215 and the exception handler 215 to receive values and/or parameters back from the embedded partition 126 via the IPB 145.

To perform and/or execute arithmetic operations and/or instructions, the example embedded partition 126 of FIG. 2 includes an arithmetic accelerator 230. The example arithmetic accelerator 230 of FIG. 2 is any variety of machine accessible instructions that may be executed by and/or within the embedded partition 126 to implement arithmetic operations corresponding to, for example, arithmetic operations from a BLAS library, vector instructions, array instructions, MMX instructions, SSE instructions, and/or VSSE instructions.

While an example arithmetic offloader 202 has been illustrated in FIG. 2, the devices, elements and/or libraries illustrated in FIG. 2 may be combined, divided, re-arranged, eliminated and/or implemented in any of a variety of ways. Further, any or all of the example library 210, the example interceptor 215, the example exception handler 220, the example interface 225 and/or, more generally, the example arithmetic offloader 202 of FIG. 2 may be implemented by hardware, software, firmware and/or any combination of hardware, software and/or firmware. Moreover, the example arithmetic offloader 202 may include additional devices, elements and/or libraries than those illustrated in FIG. 2 and/or may include more than one of any or all of the illustrated devices, elements and/or libraries.

FIG. 3 illustrates example machine accessible instructions that may be used to implement all or a portion of the example library 210 of FIG. 2. The example machine accessible instructions of FIG. 3 implement a function 305 entitled cblas_dgemm( ) of a BLAS library. As illustrated in FIG. 3, rather than the example instructions of FIG. 3 containing machine accessible instructions that directly implement the functionality of cblas_dgemm( ) function, the example instructions include machine access instructions 310 that proxy the actual computations of the arithmetic function (e.g., a SSE instruction, a VSSE instruction, a MMX instruction, a vector instruction, an array instruction, a BLAS function, etc.) to the embedded partition 126. Persons of ordinary skill in the art will readily recognize that the method of optimizing a routine of a library illustrated in FIG. 3 may be applied to any number and/or type(s) of functions and/or routines implemented by any number and/or type(s) of libraries.

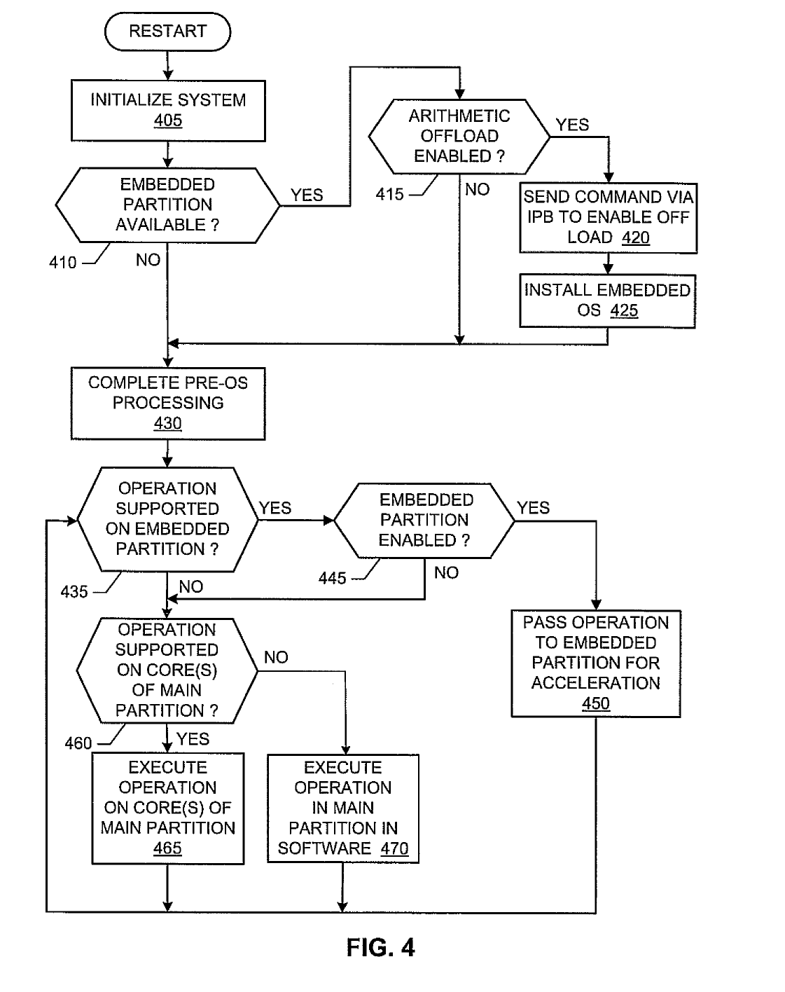

FIG. 4 is a flowchart representative of example machine accessible instructions that may be executed to implement the example general partition 125 and/or, more generally, the example processor system 100 of FIG. 1. The example machine accessible instructions of FIG. 4 may be executed by a processor, a controller and/or any other suitable processing device. For example, the example machine accessible instructions of FIG. 4 may be embodied in coded instructions stored on a tangible medium such as a flash memory, a ROM and/or RAM (e.g., any or all of the example memories 115, 140 and/or 141 of FIG. 1) associated with a processor (e.g., any or all of the example cores 120-123). Alternatively, some or all of the example flowchart of FIG. 4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example flowchart of FIG. 4 may be implemented manually or as any combination(s) of any of the foregoing techniques, for example, any combination of firmware, software, discrete logic and/or hardware. Further, although the example machine accessible instructions of FIG. 4 are described with reference to the flowchart of FIG. 4 persons of ordinary skill in the art will readily appreciate that many other methods of implementing the example general partition 125 and/or, more generally, the example processor system 100 of FIG. 1 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIG. 4 may be carried out sequentially and/or carried out in parallel by, for example, separate processing threads, processors, devices, discrete logic, circuits, etc.

The example machine accessible instructions of FIG. 4 begin with the processor system 100 initializing a main OS (e.g., the example general-purpose OS 130 of FIG. 1) (block 405). During initialization, the startup process determines whether an embedded partition (e.g., the example embedded partition 126 of FIG. 1) is available (block 410). If an embedded partition is available (block 410), the startup process determines whether an arithmetic offloader (e.g., the example arithmetic offloader 202 of FIG. 2) is enabled (block 415).

If the arithmetic offloader is enabled (block 415), the main OS 130 sends a command to the embedded partition via an IPB (e.g., the example IPB 145 of FIG. 1) to load the machine accessible instructions for the arithmetic operations and/or instructions implemented and/or provided by the embedded partition from system memory (e.g., the example system memory 141) (block 420). The arithmetic operations and/or an embedded OS in which the arithmetic operations are executed are then initialized within the embedded partition (block 425).

If the arithmetic offloader is not enabled (block 415) and/or an embedded partition is not available (block 410), control proceeds to block 430 without initializing the embedded partition and/or the embedded partition OS.

At block 430, the startup process completes the initialization of the processor system (block 430). During each instruction and/or operation request to the main OS, the arithmetic offloader (e.g., the example interceptor 215 or the example exception handler 220) determines whether or not the instruction and/or operation may be more efficiently supported by the embedded partition (block 435). If the instruction and/or operation is may be more efficiently supported by the embedded partition (block 435), the arithmetic offloader determines if the embedded partition is enabled (block 445). If the embedded partition is enabled (block 445), the arithmetic offloader (e.g., the example interface 225 of FIG. 2) passes the operation to the embedded partition for execution (block 450). Control then returns to block 435 to process the next operation and/or instruction.

If the embedded partition is not enabled (block 445) and/or the operation is not supported by the embedded partition (block 435), the arithmetic offloader determines if the operation may be processed by a core of the main partition (block 460). If the instruction and/or operation is supported by any or all cores of the main partition (block 460), the instruction and/or operation is executed and/or carried out by and/or within the main partition by the core(s) (block 465). Control then returns to block 435 to process the next operation and/or instruction.

If the instruction and/or operation is not supported by any or all cores of the main partition (block 460), the instruction and/or operation is executed and/or carried out by software executed by and/or within the main partition (block 470). Control then returns to block 435 to process the next operation and/or instruction.

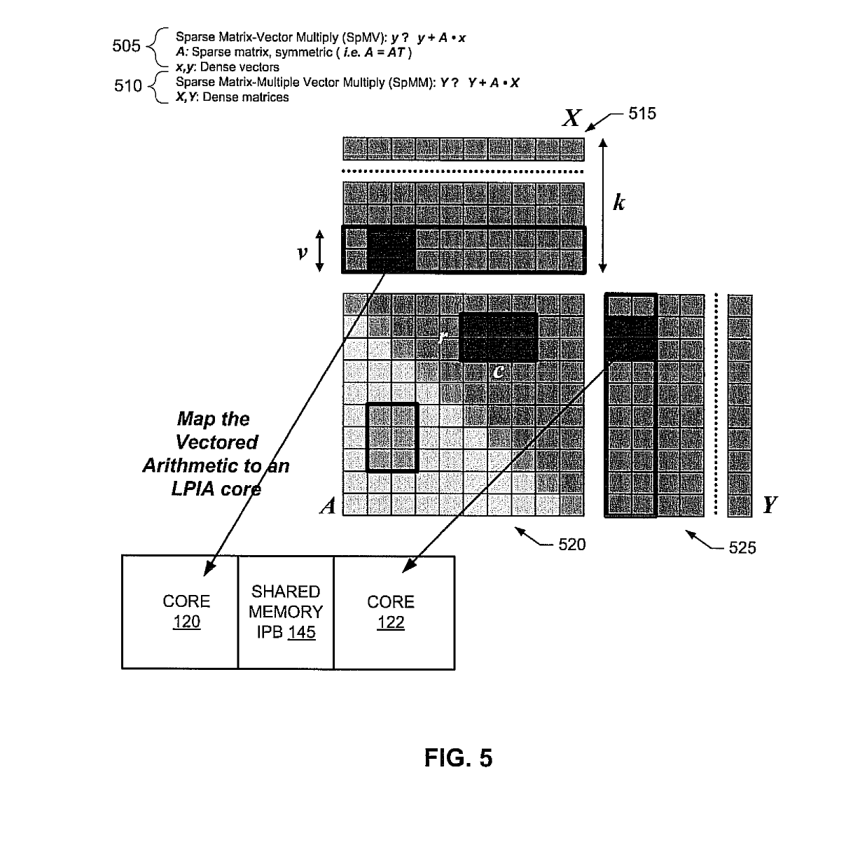

FIG. 5 illustrates an example manner of implementing vectored and array arithmetic on the example high-performance computing system 100 of FIG. 1. The example of FIG. 5 may be used to, for example, compute a sparse matrix-vector multiplication 505 or a sparse matrix-multiple vector multiplication 510. In the illustrated example, all or a portion of a matrix X 515 is mapped to a memory of the example LPIA core 120 (not shown) of the general partition 125. The matrix X 515 is shared with the example core 122 of the embedded partition 126 via a shared memory IPB 145 (e.g., a memory cache shared between and/or by the cores 120 and 121). The resultant vector Y 525 is computed by the core 122, and is mapped to a memory of the core 122 (not shown) that is available to the core 120 via the shared-memory IPB 145.

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
executing a first operating system in a first partition to detect an arithmetic instruction;
using an inter-partition bridge to notify a second partition of the arithmetic instruction; and
processing the arithmetic instruction in the second partition with a second operating system.

2. The method of claim 1, wherein the first partition is a general partition, the first operating system is a general-purpose operating system, the second partition is an embedded partition, and the second operating system is embedded operating system.

3. The method of claim 1, wherein the second operating system is configured to accelerate the execution of the arithmetic instruction on a processor core installed in the second partition.

4. The method of claim 3, wherein the processor core is a general-purpose processor core.

5. The method of claim 1, wherein the inter-partition bridge is a shared memory accessible by the first and the second partitions.

6. The method of claim 1, wherein the inter-partition bridge is an input/output controller.

7. The method of claim 1, wherein detecting the arithmetic instruction comprises detecting a call to a function.

8. The method of claim 1, wherein detecting the arithmetic instruction comprises detecting an undefined exception fault.

9. The method of claim 1, wherein detecting the arithmetic instruction comprises intercepting the arithmetic instruction.

10. The method of claim 1, wherein the arithmetic instruction is at least one of an arithmetic operation from a basic linear algebra subprograms (BLAS) library, a vector operation, an array operation, a matrix math extension (MMX) instruction, a streaming singled instruction multiple data (SSE) instruction, or a vector SSE (VSSE) instruction.

11. An article of manufacture storing machine readable instructions which, when executed, cause a machine to:
execute a first operating system in a first partition to detect an arithmetic instruction;
use an inter-partition bridge to notify a second partition of the arithmetic instruction; and
process the arithmetic instruction in the second partition with a second operating system.

12. An article of manufacture as defined in claim 11, wherein the first partition is a general partition of a computing system, the first operating system is a general-purpose operating system, the second partition is an embedded partition of the computing system, and the second operating system is embedded operating system.

13. An article of manufacture as defined in claim 11, wherein the machine readable instructions, when executed, cause the machine to:
install a processor core in the second partition; and
configure the second partition to accelerate the execution of the arithmetic instruction on the processor core.

14. An article of manufacture as defined in claim 11, wherein the inter-partition bridge is at least one of a shared memory accessible by the first and the second partitions or an input/output controller.

15. An article of manufacture as defined in claim 11, wherein the machine readable instructions, when executed, cause the machine to detect the arithmetic instruction by detecting at least one of an undefined exception fault, a call to a function, or an intercepted instruction.

16. An article of manufacture as defined in claim 11, wherein the arithmetic instruction is at least one of an arithmetic operation from a basic linear algebra subprograms (BLAS) library, a vector operation, an array operation, a matrix math extension (MMX) instruction, a streaming singled instruction multiple data (SSE) instruction, or a vector SSE (VSSE) instruction.

17. An apparatus comprising:
an arithmetic offloader to detect an arithmetic instruction in a first partition;
a second partition to process the arithmetic instruction; and
an inter-partition bridge to notify the second partition of the arithmetic instruction.

18. An apparatus as defined in claim 17, wherein the first partition is configured to implement a general-purpose operating system, and the second partition is an embedded partition configured to implement an embedded operating system.

19. An apparatus as defined in claim 17, wherein the second partition comprises a processor core, and wherein the second partition is configured to accelerate the execution of the arithmetic instruction on the processor core.

20. An apparatus as defined in claim 17, wherein the inter-partition bridge is at least one of a shared memory accessible by the first and the second partitions, or an input/output controller.

21. An apparatus as defined in claim 17, wherein the arithmetic offloader comprises a library to initiate the processing of the arithmetic instruction by the second partition.

22. An apparatus as defined in claim 17, wherein the arithmetic offloader comprises an exception hander to detect an undefined exception fault and to initiate the processing of the arithmetic instruction by the second partition.

23. An apparatus as defined in claim 17, wherein the arithmetic offloader comprises an interceptor to intercept the arithmetic instruction and to initiate the processing of the arithmetic instruction by the second partition.

24. An apparatus as defined in claim 17, wherein the arithmetic instruction is at least one of an arithmetic operation from a basic linear algebra subprograms (BLAS) library, a vector operation, an array operation, a matrix math extension (MMX) instruction, a streaming singled instruction multiple data (SSE) instruction, or a vector SSE (VSSE) instruction.
